(19) United States
(12) Patent Application Publication
(10) Pub. No.: US 2018/0290416 A1
(43) Pub. Date: Oct. 11, 2018

(54) SINGLE-PLY LINER LABEL COMBINATION AND ROLL

(71) Applicant: Iconex LLC, Duluth, GA (US)

(72) Inventors: Roger Francoeur, Bennington, NE (US); Timothy Darren Livingston, Corryton, TN (US); James L. Wilkins, Russellville, TN (US)

(21) Appl. No.: 15/943,868

(22) Filed: Apr. 3, 2018

Related U.S. Application Data
(63) Continuation-in-part of application No. 15/411,453, filed on Jan. 20, 2017.

(51) Int. Cl. B31D 1/02; B65C 9/18

(52) U.S. Cl. CPC B31D 1/021; B65C 9/1869; B31D 1/027

(57) ABSTRACT

A single-ply liner label combination and liner-label combination roll are provided. Each liner label combination including a liner substrate and a label substrate. The label substrate including at least one inner and partially perforated second label. The backside of the label substrate including adhesive but a first portion of an area of the backside that corresponds to the inner and partially perforated second label including an adhesive deadener applied over the adhesive within the first portion. A second portion of the area retains the adhesive in a pattern along a periphery of the backside that corresponds to the inner and partially perforated second label.

### RELATED APPLICATIONS

The present application claims priority to and is a Continuation-In-Part (CIP) of co-pending U.S. application Ser. No. 15/411,453, entitled: “Two-Ply Channel Liner, Label, and Roll,” filed on Jan. 20, 2017; the disclosure of which is incorporated by reference herein in its entirety.

### BACKGROUND

The ubiquitous adhesive label is available in a myriad of configurations for use in various applications, including specialty applications. The adhesive label includes an adhesive on its back side and is initially laminated to an underlying release liner.

Adhesive labels may be found in individual sheets, or joined together in a fan-fold stack, or in a continuous roll (web). Label rolls are typically used in commercial applications requiring high volume use of labels.

The challenge with liner-based adhesive rolls is that as the label is removed from the liner while the web is processed through an auto applicator machine and the label is affixed to a package, the underlying liner is rewound as waste in the machine and the tension in the liner grows causing the liner to break. Swapping out the feed roll and/or removing the waste-liner roll means stopping the machine and having specialized staff remove the waste-liner roll and refeed (rethread) the remaining combined liner-label roll for continued processing or swapping out the liner-label roll with a new liner-label roll. Because of this tension in the liner between the feed roll and the accumulating waste roll, the size of the waste-liner label roll is limited (meaning the total number of labels that can be applied to packaging by the machine before waste-liner roll is removed and/or a new liner-label roll is refed in the machine is limited).

In some industry applications it is desirable to apply a label to a package initially and at a later point in processing the package be able to remove a portion of that label to retain some of the printed information. This is commonly accomplished by constructing the label with two liners, such that the first liner (or bottom liner) is used as a carrier during the auto application process, and the second liner provides a way to remove a portion of the label after the label has been affixed to a package. However, 1) this additional substrate is costly to manufacture; 2) label capacity through conventional auto applicator machines has stagnated, and 3) the three-ply approach creates greater waste byproduct (three substrates).

### SUMMARY

In various embodiments, a liner-label combination, a liner-label combination roll, and an auto applier machine are provided.

According to an embodiment, a liner-label combination is provided. The liner label combination includes: a liner substrate, a label substrate, and a partially perforated inner label within the label substrate. Furthermore, a first portion of a backside area of the label substrate representing the partially perforated inner label includes an adhesive deadener applied over an adhesive coated on a backside of the label substrate while a second portion of the backside area retains the adhesive.

### BRIEF DESCRIPTION OF THE DRAWINGS

FIG. 1A is a diagram of a liner-label combination, according to an example embodiment.

FIG. 1B is a diagram of an example liner-label combination, according to an example embodiment.

FIG. 1C is a diagram of a backside of a perforated label included in a label combination, according to an example embodiment.

FIG. 2 is a diagram of a liner-label combination roll having label combinations, according to an example embodiment.

FIG. 3 is a diagram an auto applicator machine for applying a combination label to packaging from the liner-label combination roll and winding the waste-liner roll within the auto applicator machine, according to an example embodiment.

### DETAILED DESCRIPTION

As will be described more completely herein and below, a single-ply liner-label combination, a liner-label combination roll, and an auto applicator are presented.

The term “perforated” is a weakened structure defined within a substrate through tiny holes manufactured in the substrate.

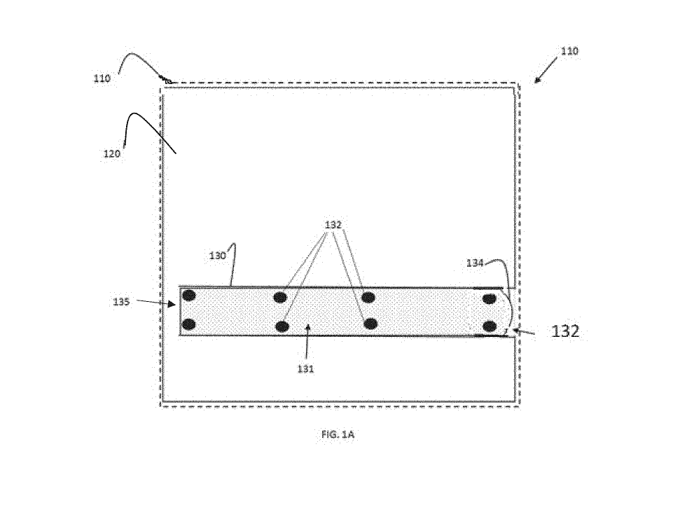

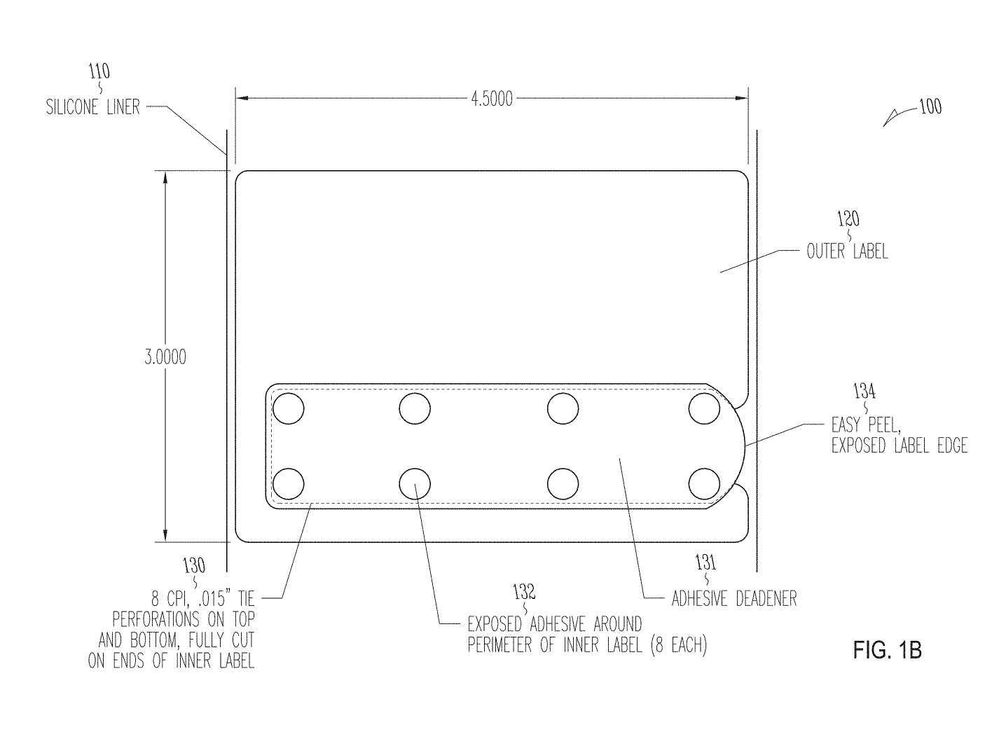

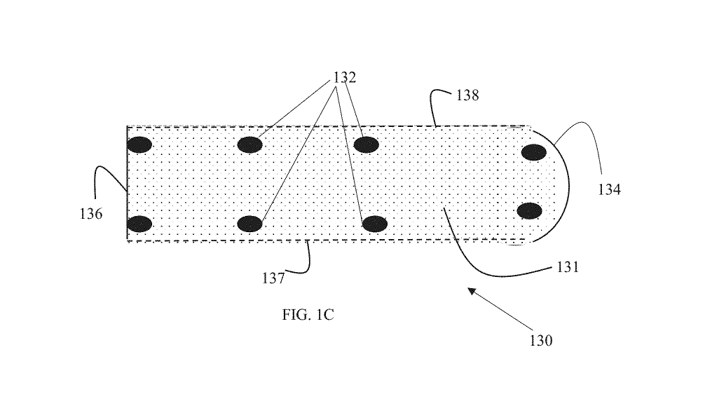

FIG. 1A is a diagram of a liner-label combination 100, according to an example embodiment. It is noted that the dimensions of the liner 110 and the combination label 120 (130 is a second label removable from label 120) can vary in various embodiments presented herein and below. An example combination label 120 along with dimensions is presented in the FIG. 1B.

The liner-label combination 100 includes: a liner 110 and a label combination 120. The label combination 120 includes a second embedded perforated label 130.

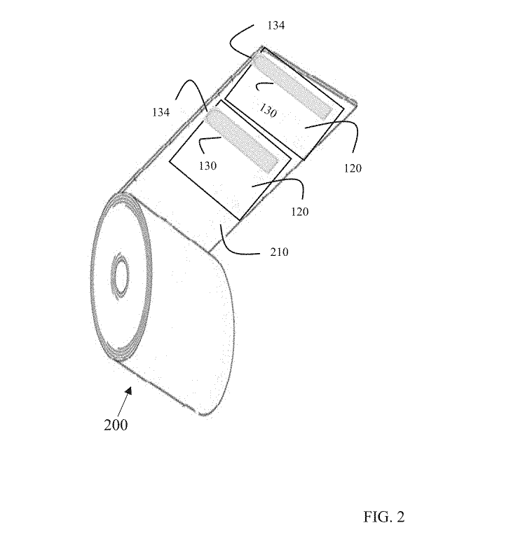

The liner 110 is part of a web or roll 200 (discussed below with reference to the FIG. 2). The liner 110 is a substrate coated with a release coating (water-based substantially free of silicone or silicon-based).

In an embodiment, the liner 110 is a film. The film is a plastic-based substrate.

In an embodiment, the liner 110 is a paper-material substrate.

The liner 110 representing a first substrate to which the backside of the label combination 120 (representing a second substrate) is applied. The backside of the label combination 120 includes an adhesive except for select portions of backside where the second perforated label 130 is defined where an adhesive deadener 131 is applied (the details of which will be discussed more completely below).

The label combination 120 includes a perforated second embedded label 130. The perforated second label 130 is situated near a bottom of the label combination 120 and runs horizontally for substantially the width of the label combination 120. A small offset 135 provides a space between a first end of the perforated second label 130 and an edge of the label combination 120. The opposite end 134 of the perforated second label 130 is rounded (half circle, convex shape) such that there are small gaps 132 between the outer edge of the perforated second label 130 and a corresponding edge of label combination 120. The farthest edge the end 134 is substantially inline and serves as an edge section of label combination 120.

In an embodiment, the ends of the perforated second label 130 are not perforated within 120 (134 and the corresponding opposite end adjacent to 135). Rather, just the pair of edges running for the width of 130 and parallel to the bottom edge and top edge of 120 are perforated.

The end 134 provides a tab mechanism for separating the perforated second label 130 from the label combination 120 to utilize the perforated second label 130 as an independent label 130 from a remaining portion of the label combination 120. That is, the label combination 120 when imaged provides imaged information on the portion of the label combination 120 that remains when the perforated second label 130 is removed and other imaged information on the perforated second label 130. In this way, the label combination 120 provides two independent labels (the remaining portion of 120 when 130 is separated therefrom and the perforated second label 130).

The structure and shape of the end 134 provides an easy mechanism for separating 130 from 120 (along with the combination of adhesive deadener 131 discussed below).

The backside of 120 (label combination) is coated with adhesive. This backside of 120 includes a backside of 130 (since 120 and 130 are manufactured from the same substrate). The area that represents the backside of 130 is illustrated in the FIG. 1A to show that a substantial portion that area for 130 is coated with an adhesive deadener 130.

The deadener 131 prevents a substantial portion of the backside of the perforated second label 130 from completely adhering to packaging when the backside of 120 is affixed or applied to packaging (once 120 is separated from the liner 110).

However, not all of the area representing the backside of 130 includes the adhesive deadener 131; rather, small patches of adhesive 132 are manufactured to remain. (Eight of these patches 132 are illustrated in the FIG. 1A although only four were labeled for ease of illustration.)

The patches 132 are evenly spaced along a periphery of the backside of 130. This arrangement provides sufficient adhesive strength for 130 to adhere to the packaging to which 120 is adhered while at the same time not too much adhesive strength such that 130 can be removed from the packaging and separated (intact and undamaged) from both 120 and the packaging to which 120 is adhered. Again, 130 is separated from both the packaging and 120 by grasping end 134 and lifting up while pulling towards the opposite edge of 120.

In an embodiment, the patches 132 represent a pattern that is maintained on the backside of 130 by printing or applying the adhesive deadener 131 over the adhesive coated on the backside of 130 such that the pattern of remaining adhesive 132 remains on the backside of 130. The location of the pattern is maintained along the edges (periphery) of the backside of 130.

This pattern of remaining adhesive patches 132 allows the inner perforated second label 130 to release for corrugated boxes and other package materials while still adhering well to bond paper (when subsequently reapplied to the bond paper or other different packaging material.

It is noted that the carrier layer does not require any die cuts such that the original web strength (when the combination label 120 is part of a web of combination labels) is retained eliminated risk of breaking the web.

This liner label combination 100 significantly reduces the overall cost of the label combination 120, improves the converting process, and greatly reduces tooling wear.

In an embodiment, the label combination 120 includes more than one (a plurality of two or more) perforated second labels 130 manufactured in the same manner with the adhesive deadener 131 the remaining adhesive patches 132, and the release end 134 for releasing from 120 as two or more separate and independent labels 130.

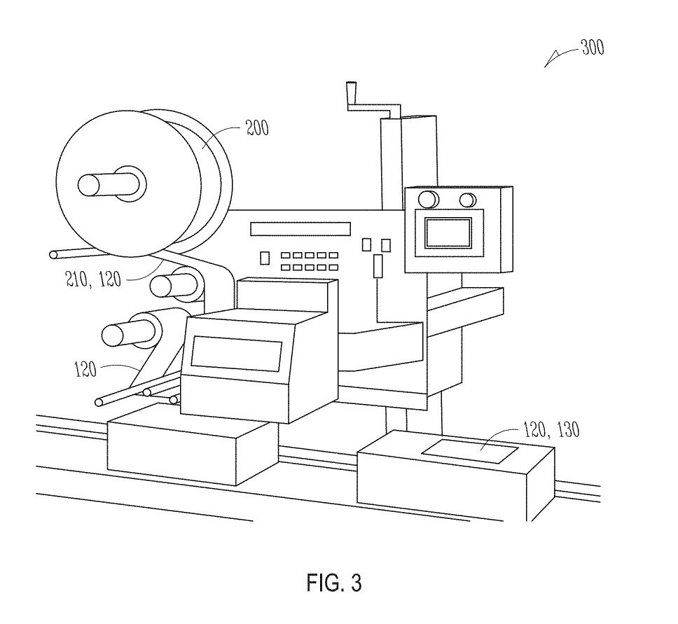

The label combination 120 can be included in a roll (web) having a plurality of label combinations 120. An auto applicator machine (such as 300 discussed below with the FIG. 3) is loaded with the liner-label combination 100 and automatically removes the label 120 from the liner 110 and applies the label 120 to packaging that passes under a portion of the machine on a transport belt (conveyor belt). When the package is received, the recipient can remove the second label 130 from the label 120 that is affixed to the package (in the manner discussed above). The second label 130 can then be applied to other items/objects, such as a product (the front side of the second label 130 including printed information thereon, such as a barcode or Quick Response (QR) code or other written information and/or graphics).

The front side of the label 120 and the second label 130 includes printed information when custom printed or imaged during application within a printer.

FIG. 1B is a diagram of an example liner-label combination 100, according to an example embodiment. The FIG. 1B provides dimensions for an example liner-label combination 100.

The height of the label combination 120 is approximately 3 inches and the width approximately 4.5 inches. The inner perforated second label 130 is defined within the label combination 120 through 8 cpi 0.15 inch tie perforations on top and bottom while the ends remain full cut and not perforated (ends 134 and the corresponding opposite end of 130). Adhesive deadener 131 is applied over the adhesive on the backside of 130 leaving small patches of adhesive on the backside of 130 that retain the original adhesive in a pattern around the perimeter of 130.

Again, the backside of the label 120 (including just the adhesive patches 132 of the inner perforated label 130) includes an adhesive coating such that when the label 120 is removed as a unit (including the second label 130) from the liner 110, the label 120 and 130 adheres to the packaging. The label 130 is removed through edge 134 from such packaging and released by the perforations and adhesive deadener 131. The label 130 can then be reapplied to the same or different packaging materials utilizing the remaining adhesive patches 132.

FIG. 1C is a diagram of a backside of a perforated label 130 included in a label combination, according to an example embodiment.

Edges 137 and 138 are perforated within the substrate that comprises the label combination 120. Edges 134 and 136 are intact and not perforated. Adhesive deadener 131 is printed or applied over original adhesive that is coated on the backside of 130 except not in areas where the original adhesive is allowed to remain in a discontinuous set of adhesive patches 132, discontinuous because between each patch 132 there is adhesive deadener 131.

Edge 134 provides a tab for lifting and separating 130 from 120 and the packaging materials to which 120 is adhered to through the original adhesive coated on the backside of 120. The deadener 131 and the perforated edges 137 and 138 substantially reduce the adhesion of the backside of 130 to the packaging materials allowing reduced force to separate 130 from the packaging materials while keeping the structure integrity of a remaining portion of 120 that remains on the packaging materials intact.

FIG. 2 is a diagram of a liner-label combination roll 200 having, according to an example embodiment.

The liner-label roll 200 that includes two substrates one for the liner 110 and one for the label combination 120. The substrate 210 in the FIG. 2 represents the substrate for the label combination 120. Each individually defined label combination 120 of the roll (web) 200 includes at least one embedded inner perforated label 130. Each label 120 may include preprinted information thereon or may include no printing that can subsequently be printed upon with information to define an individual label 120 and the embedded perforated label(s) 130. Printing on a front side of each label 120 and 130 can occur through thermal printing (such as when the front side of the second substrate includes a thermally activated coating) or can occur through laser or dot matrix printing.

Again, each label 120 that defines at least one independent removable second label 130 within label 120. The backside of the second substrate 210 is coated with an adhesive so it sufficiently adheres to the front side of the first substrate 210; however, as shown in the FIGS. 1A-1C a portion of the backside of the second substrate that represents the backside of one of the second labels 130 includes adhesive deadener 131 coated over the adhesive leaving a pattern of adhesive patches 132 remaining on the backside of the second labels.

The tabs 134 are offset slightly and include a portion that represent an edge of 120. The tabs 134 along with the adhesive deadener 131 allow easy gripping and separation of the labels 130 from 120 and any subsequent packaging materials to which 120 is affixed (as discussed above).

FIG. 3 is a diagram an auto applicator machine 300 for applying a label to packaging from the liner-label combination roll and winding the waste-liner roll within the auto applicator machine, according to an example embodiment.

The auto applicator machine 300 presented is one type of auto applicator machine 300. That is, other types and configurations can be used with the novel liner-label combination rolls 200 and liner-labels combinations 120 presented herein and above.

A liner-label combination roll 200 is loaded into the machine 300 and the front surface 210 having the labels 120 with the inner labels 130 are oriented properly during the load. The machine 300 removes the label 120 that includes the perforated label 130 from the liner 110 and automatically applies to packaging. The liner 110 is then fed into a waste-liner roll (bottom spool in the FIG. 5).

The package can then be delivered and an operator can remove the label 130 from the package using tab 134. The removed label 130 includes the remaining adhesive patches 132 on its backside, such that the removed label 130 can be applied to a product (item or object) or the same (same as 120) or other packaging material.

One now appreciates how the novel label combination 120 and liner-label combination roll 200 can improve cost of manufacture for labels, improves the converting process, and greatly reduces tooling wear.

Although the present invention has been described with particular reference to certain preferred embodiments thereof, variations and modifications of the present invention can be effected within the spirit and scope of the following claims.

1. A liner-label combination, comprising:
a liner substrate;
a label substrate;
a partially perforated inner label within the label substrate; and
wherein a first portion of a backside area of the label substrate representing the partially perforated inner label includes adhesive deadener applied over an adhesive coated on a backside of the label substrate, and a second portion of the backside area retains the adhesive.

2. The liner-label combination of claim 1, wherein the partially perforated inner label includes two parallel perforated edges and two opposite edges that are not perforated.

3. The liner-label combination of claim 2, wherein one of the two opposite edges is in a convex or half-circle shape that aligns with a corresponding edge of the label substrate.

4. The liner-label combination of claim 3, wherein the convex or half-circle shape providing a rounded tab for removing the partially perforated inner label from the label substrate.

5. The liner-label combination of claim 1, wherein the second portion represents a pattern of remaining adhesive along a periphery of the backside.

6. The liner-label combination of claim 5, wherein the pattern is discontinuous adhesive patches along the periphery that remained uncoated by the adhesive deadener.

7. The liner-label combination of claim 1, wherein the partially perforated inner label is situated proximate to a bottom edge of the label substrate.

8. The liner-label combination of claim 1, wherein a remaining portion of the label substrate when the partially perforated inner label is removed from the label substrate represents an independent label from the partially perforated inner label.

9. A liner-label combination roll, comprising:
a liner; and
a plurality of label combinations applied to a front side of the liner, each label combination including at least one perforated inner second label;
wherein a backside of the label combinations include an adhesive to adhere the label combinations to a front side of the liner;
wherein select areas on the backside of the label combinations includes an adhesive deadener applied over the adhesive, each select area representing a first portion of a backside of a particular perforated inner second label with a second portion of that backside including a pattern of remaining adhesive that remains along edges of that backside.

10. The liner-label combination roll of claim 9, wherein each perforated inner second label including a first pair of opposing edges that are parallel to one another and are perforated within a corresponding label combination.

11. The liner-label combination roll of claim 10, wherein each perforated inner second label including a second pair of opposing edges that are not perforated within the corresponding label combination.

12. The liner-label combination roll of claim 11, wherein one edge from the second pair of opposing edges configured as a release edge to separate a given perforated inner second label from the corresponding label combination.

13. The liner-label combination roll of claim 12, wherein the release edge is shaped as a half circle proximate to a corresponding edge of the corresponding label combination.

14. The liner-label combination roll of claim 9, wherein the remaining adhesive is a plurality of adhesive patches arranged in the pattern.

15. The liner-label combination roll of claim 14, wherein each of the adhesive patches are separated from one another by the adhesive deadener.

16. The liner-label combination roll of claim 9, wherein the remaining adhesive is situated along a periphery proximate to the edges.

17. The liner-label combination of claim 9, wherein the liner is a film-based substrate.

18. The liner-label combination of claim 9, wherein the liner is a paper-based substrate.

19. An auto applicator machine, comprising:
a liner-label combination roll configured to be loaded into the auto applicator machine for label processing on packages, wherein the liner-label combination roll includes a liner and labels applied to the liner, each label including at least one inner perforated second label, and each inner perforated second label including a rounded release edge for removing that inner perforated second label from a corresponding label and a corresponding package to which the corresponding label has been affixed to by the auto applicator machine; and
a waste-liner roll wound by the auto applicator machine as the labels are removed from the liner-label combination roll and as the labels are adhered to the packages;
wherein a first portion of a backside of each inner perforated second label includes an adhesive deadener while a second portion of the backside includes adhesive patches.

20. The auto applicator machine of claim 19, wherein the adhesive patches are arranged in a pattern along a periphery of the backside for each inner perforated second label, each adhesive patch separated from adjacent adhesive patches by the adhesive deadener.
